(19) United States
(12) Patent Application Publication
(10) Pub. No.: US 2008/0128504 A1
(43) Pub. Date: Jun. 5, 2008

(54) Printed material reader

(76) Inventors: Henry Liming Wang, Cerritos, CA (US); Joseph Phillip Mauriello, Huntington Beach, CA (US)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/606,601

(22) Filed: Nov. 30, 2006

(51) Int. Cl. G06K 7/10

(52) U.S. Cl. 235/462.1

(57) ABSTRACT

A sheet (16) contains an image (12) that is recognizable by a person, such as an image of a dog, and also contains a machine readable graphic symbol such as a two-dimensional bar code (20). An electronic reader (22) scans the graphic symbol and generates a sound (32) such as the sounded, or pronounced word “dog”. Letters of the alphabet, such as letters that spell “D-O-G” (14), are printed directly on the two-dimensional bar code. The two-dimensional bar code can be read forward to sound the English word “dog” and can be scanned rearward to pronounce the translated word in Spanish such as “perro”.

### BACKGROUND OF THE INVENTION

One type of elementary educational toy is a book with a picture on each page and a bar code under each picture. A child “scans” the bar code, and that results in an electronic circuit making a sound that is the pronunciation, or sounding, of the word. This system also can be used to teach a person a foreign language, or to sound the bird call of a species depicted in the picture. The most common type of bar code includes a series of about 20 machine-readable printed elements, such as vertical lines separated by vertical spaces, and this is sometimes referred to as a “one-dimensional” bar code.

Another type of bar code that has been proposed is the “two-dimensional” bar code which contains a large number of machine-readable elements. One example of a two dimensional bar code is described in U.S. Pat. No. 6,095,418, which describes a bar code that can be printed on a portion of a page and that represents the text on a page.

It would be desirable if the high capacity of a two-dimensional bar code could be used to create simple printed sheets of even greater usefulness and entertainment.

### SUMMARY OF THE INVENTION

In accordance with one embodiment of the present invention, a combination is provided of a page containing a word and a graphic symbol such as a bar code, and a reader that is used to scan the graphic symbol and generate a sound related to the graphic symbol. The machine readable graphic symbol represents a dictionary word, and the electronic reader is constructed to generate a sound that is a pronunciation of the word.

In one combination, the graphic symbol is a two-dimensional bar code, and the word is printed directly on the two-dimensional bar code. As a result, a person scans the very printed word whose pronunciation is desired. In one combination that is used to help a person learn a second language, the scanner can be operated to scan the bar code backward or forward. The reader sounds the word in different languages, depending upon the direction of scanning. For example, when the bar code is scanned forward, an English word is pronounced that corresponds to a picture on that page, while when the bar code is scanned backward a Spanish word is sounded which is a translation of the English word. Phrases can be pronounced, such as those that correspond to a situation depicted in a picture on the page.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an isometric view of a combination of a page with a picture and a graphic symbol thereon, and an electronic reader that is constructed to scan the graphic symbol and pronounce a word.

FIG. 2 is a simplified front elevation view of the two-dimensional bar code of the graphic symbol of FIG. 1.

FIG. 3 is an isometric view of a portion of a combination of a page with a picture and graphic symbol thereon, and an electronic reader of another embodiment of the invention.

### DETAILED DESCRIPTION OF THE INVENTION

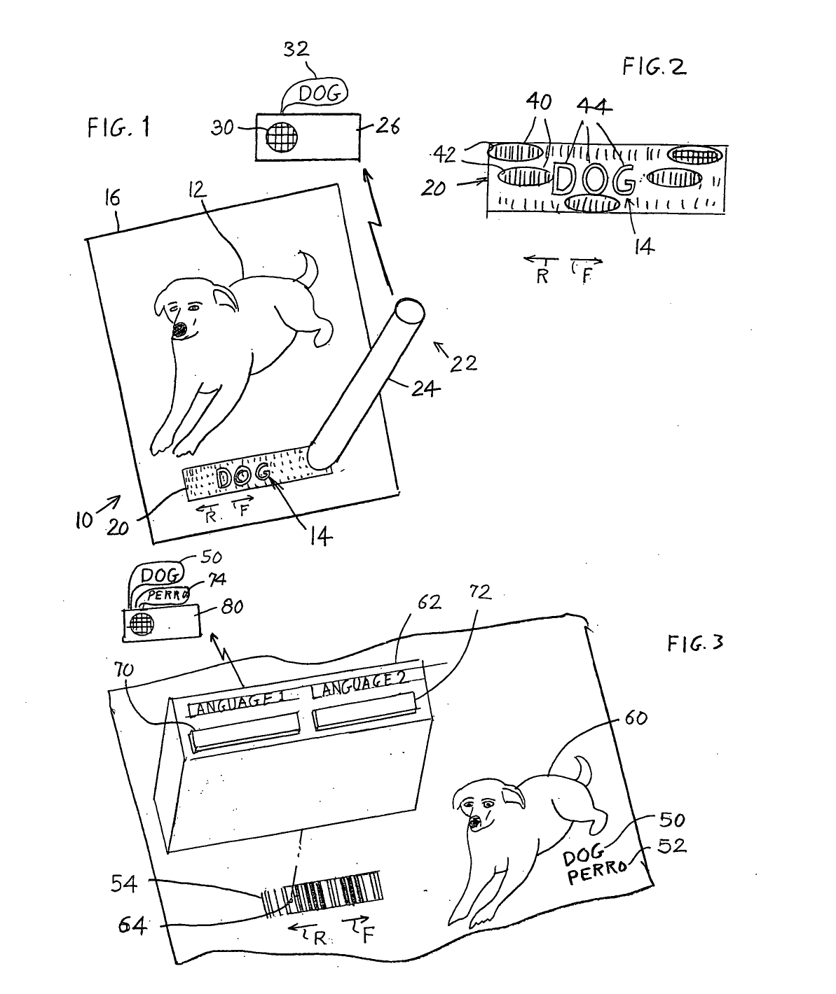

FIG. 1 illustrates a system 10 that can sound, or pronounce, a word that corresponds to a picture 12 and to a printed word 14 on a sheet of paper or page 16. A graphic symbol 20 that is machine readable is also printed on the page. The system also includes an electronic reader 22 of a type that includes a scanner 24 that scans the graphic symbol, and that is coupled by wires, or electromagnetic energy (e.g. radio or infrared) to a circuit 26. The circuit 26 delivers electronic signals to a speaker 30 to produce a sound that is a pronunciation of a word represented by the picture 12 and of the printed word 14. In FIG. 1, the sound is indicted by a word in a balloon 32, in the same way that sounds are indicated in cartoons.

The system 10 is designed for use or play by children to help them learn to read, by themselves. A child can read the word 14 and say it. The child then checks whether or not he/she is correct by operating the scanner 24 by moving it along the graphic symbol 20, and listening to the sound output of the speaker. The picture 12 is useful to help the child, at least at the beginning.

FIG. 2 shows one possible form of graphic symbol 20. The graphic symbol has many identical miniature bar codes 40, each lying within an area 42 that applicant has marked with an ellipse in FIG. 2 (although the ellipses are not present in the actual graphic symbol). Each bar code 40 represents a word to-be-sounded The graphic symbol also includes letters 44 that form the word 14 superposed on bar codes of the two dimensional bar code of the graphic symbol 20. When the graphic symbol 20 is read, the scanner scans a broad and long area that usually contains a plurality of bar codes, as well as the printed word 14. The circuit 26 ignores letters of the word 14, and registers the reading of only one of the plurality of bar codes that may be read. The circuit feeds electric signals to the speaker that causes the sounding of the word to-be-sounded represented by one of the bar codes.

The placement of a printed word 14 to-be-sounded superposed on the two-dimensional bar code that represents the word to-be-sounded, has the advantage that the child readily learns that he/she must scan the area that contains the word 14. If the printed word were elsewhere on the page, then the child would have to learn that he/she must find letters on the page that represent a word, pronounce that word, and then scan a separate graphic symbol area. In FIG. 1, the child learns that he/she must read a printed word and pronounce the word, and then scan the same area that he/she reads. The child then compares the sound that he/she makes with the sound made by the speaker 30. In some cases, one or more words are printed on a page outside the area of the scannable graphic symbol 20, and the distinctive two-dimensional bar code and superposed printed letters that form a word, are easily differentiated from other words. The system 10 of FIG. 1 is useful to teach an adult (as well as a child) a foreign language. The graphic symbol 20 can be scanned forward F or rearward R, and therefore each of the miniature bar codes 40 can be scanned rearward R (Right-to-left) as well as forward F (which is usually left to right). When the graphic symbol is scanned forward F, the circuit 26 pronounces the English word. When the graphic symbol is scanned rearwardly, it pronounces the word as translated into a second language, such as Spanish.

FIG. 3 shows a system similar to that of FIG. 1, except that an English language word 50 and its Spanish equivalent 52 are both printed on the page, but not on a graphic symbol 54. The printed words are located under a picture 60 that represents the word. The graphic symbol is a simple one-dimensional bar code. A scanner 62 of the system, is an automatic scanner that can direct a light beam spot 64 (e.g. laser) at the graphic symbol and sweep it across the symbol. When a button 70 on the scanner is pressed, the scanner operates to sweep the spot from left to right. Then, circuit 80 pronounces the English word 50, which in this case is “DOG”. When another button 72 on the scanner is pressed, the scanner operates to sweep the spot from right to left, and the circuit pronounces the Spanish word “PERRO” 74 which is the Spanish equivalent of “DOG”. A scanner of the type shown in FIG. 1 at 22 can be used instead, which must be moved across the graphic symbol by hand, either forward F or rearward R. The scanner 62 with self sweeping capability is more expensive than the hand-moved scanner 24 of FIG. 1.

Thus, the invention provides a system that facilitates the effort of a person to learn to read words, as by a child who is learning to read in his native language, or by an older child or adult who is learning a second language. The system includes a page that preferably has a picture and a word printed thereon, and a graphic symbol in the form of a one or two dimensional bar code. Where a two dimensional bar code is printed on the page, the word readily can be printed directly on the bar code so it is superposed thereon. Where a one dimensional bar code is used, the word preferably is not printed to be superposed on the bar code. In either case, a scanner that machine-reads the bar code, can be used to scan the bar code forward to cause the word to be sounded in one language such as English, and can be used to scan the bar code rearward to cause the word to be sounded in a different language such as Spanish. The page or letters on a two-dimensional bar code can be short phrases instead of individual words on the page and in the bar codes, so a “word” can be part of a phrase.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A combination of a page containing a machine readable graphic symbol and an electronic reader for scanning said machine readable graphic symbol and generating a sound related to said graphic symbol, wherein:
said machine readable graphic symbol includes machine readable elements that represent a word to-be-sounded and said electronic reader is constructed to produce sounds that pronounce a word that has the same meaning as said word to-be-sounded when the electronic reader scans said graphic symbol;
said graphic symbol also contains letter of the alphabet that spell said word to-be-sounded, said letters of the alphabet lying superposed on the machine readable graphic symbol that is scanned by the electronic reader.

2. The combination described in claim 1 wherein:
said machine readable graphic symbol comprises a two-dimensional bar code, said machine readable elements that represent a dictionary word occupy only part of the area of the two-dimensional bar code, and said letters of the alphabet that spell said word to-be-sounded occupy another part of the area of the two-dimensional bar code.

3. The combination described in claim 1 wherein:
said letters of the alphabet that spell said word to-be-sounded are in a first language, and said sounds that pronounce a word pronounce a word in a second language.

4. The combination described in claim 1 wherein:
said electronic reader is operable in a first mode to scan said graphic symbol in a first direction and is operable in a second mode to scan said graphic symbol in a second direction;
said letters of the alphabet that spell said word to-be-sounded are in a first language, said electronic reader is constructed to produce sounds that pronounce a word having said meaning in said first language when said electronic reader is operated in said first mode, and to produce sounds that pronounce a word having said meaning but in a second language that is different from said first language, when operated in said second mode.

5. A combination of a page with alphabet letters on said page that spell a word that has a predetermined meaning and with a machine readable graphic symbol on said page, said combination also including an electronic reader for scanning said graphic symbol and generating a sound related to said graphic symbol, wherein:
said electronic reader is operable in first and second modes to respectively scan the graphic symbol in first and second directions;
in said first mode wherein said electronic reader scans in said first direction, said electronic reader pronounces a word in a first language having said predetermined meaning;
in said second mode wherein said electronic reader scans in said second direction, said electronic reader pronounces a word in a second language having said predetermined meaning.

6. The combination described in claim 5 wherein:
said alphabet letters lie superposed on said machine readable graphic symbol.
